(19) United States
(12) Patent Application Publication
(10) Pub. No.: US 2026/0177480 A1
(43) Pub. Date: Jun. 25, 2026

(54) GAS DETECTION APPARATUS

(71) Applicant: Asahi Kasei Microdevices Corporation, Tokyo (JP)

(72) Inventors: Keiichiro KUWATA, Tokyo (JP); Edson Gomes CAMARGO, Tokyo (JP)

(73) Assignee: Asahi Kasei Microdevices Corporation, Tokyo (JP)

(21) Appl. No.: 19/426,417

(22) Filed: Dec. 19, 2025

(30) Foreign Application Priority Data
Dec. 25, 2024 (JP) 2024-229234
Oct. 1, 2025 (JP) 2025-165776

(51) Int. Cl. G01N 21/3504

(52) U.S. Cl. CPC G01N 21/3504

(57) ABSTRACT

Provided is a gas detection apparatus with which good optical properties are obtained. A gas detection apparatus (1) includes a substrate (2), a light-emitting section (3), a light-receiving section (4), a light-guiding section (5), and a fixing section that fixes the light-guiding section (5) and the substrate (2). The light-guiding section (5) includes at least two leg sections (54), the substrate (2) includes at least two position reference sections (63) that are in contact with the leg sections (54), a position of the light-guiding section (5) in a perpendicular direction relative to the substrate (2) is set by the position reference sections (63), and the fixing section is a structure that is independent of the position reference sections (63) and the leg sections (54).

### TECHNICAL FIELD

The present disclosure relates to a gas detection apparatus.

### BACKGROUND

A known conventional gas detection apparatus 105 includes a substrate 100, a light-emitting section 101 and a light-receiving section 102 that are provided on the substrate 100, and a light-guiding section 104 that is provided on the substrate 100 via an adhesive 103 (refer to FIG. 6).

### CITATION LIST

### Patent Literature

PTL 1: JP 2021-144027 A

### SUMMARY

However, with the conventional gas detection apparatus, variation in production due to differing adhesive thickness or the like has meant that positions of the light-emitting section, the light-receiving section, and the light-guiding section have not been set, particularly in a perpendicular direction relative to the substrate. This has resulted in a problem that deviation of the position of the light-guiding section relative to the light-emitting section or light-receiving section arises and that optical properties of the gas detection apparatus deteriorate. Moreover, this problem becomes more evident as the size or height of the gas detection apparatus is reduced because when the light-guiding section and the light-emitting section or light-receiving section are closer together, a certain amount of deviation of the position of the light-guiding section results in a larger relative amount of deviation of position relative to the distance between the light-guiding section and the light-emitting section or light-receiving section.

An object of the present disclosure, which was completed in view of the above, is to provide a gas detection apparatus with which good optical properties are obtained.

A gas detection apparatus according to an embodiment of the present disclosure comprises: a substrate; a light-emitting section that is provided on the substrate; a light-receiving section that is provided on the substrate; a light-guiding section that is provided on the substrate and that guides light that has been emitted from the light-emitting section to the light-receiving section; and a fixing section that fixes the light-guiding section and the substrate, wherein the light-guiding section includes at least two leg sections, the substrate includes at least two position reference sections that are in contact with the leg sections, a position of the light-guiding section in a perpendicular direction relative to the substrate is set by the position reference sections, and the fixing section is a structure that is independent of the position reference sections and the leg sections.

According to an embodiment of the present disclosure, it is possible to provide a gas detection apparatus with which good optical properties are obtained.

### BRIEF DESCRIPTION OF THE DRAWINGS

In the accompanying drawings:

FIG. 1A is a schematic cross-sectional view illustrating an example of configuration of a gas detection apparatus according to an embodiment of the present disclosure;

FIG. 1B is a schematic upper surface view illustrating an example of configuration of a gas detection apparatus according to an embodiment of the present disclosure;

FIG. 2 is a schematic lower surface view illustrating an example of configuration of a light-guiding section in a gas detection apparatus according to an embodiment of the present disclosure;

FIG. 3 is a cross-sectional photograph illustrating an example of configuration of a light-guiding section in a gas detection apparatus according to an embodiment of the present disclosure;

FIG. 4 is a schematic cross-sectional view and a schematic lower surface view illustrating an example of configuration of a gas detection apparatus according to a modified example;

FIG. 5 is a schematic cross-sectional view illustrating an example of configuration of a gas detection apparatus according to a modified example; and

FIG. 6 is a schematic cross-sectional view illustrating an example of configuration of a gas detection apparatus according to a conventional example.

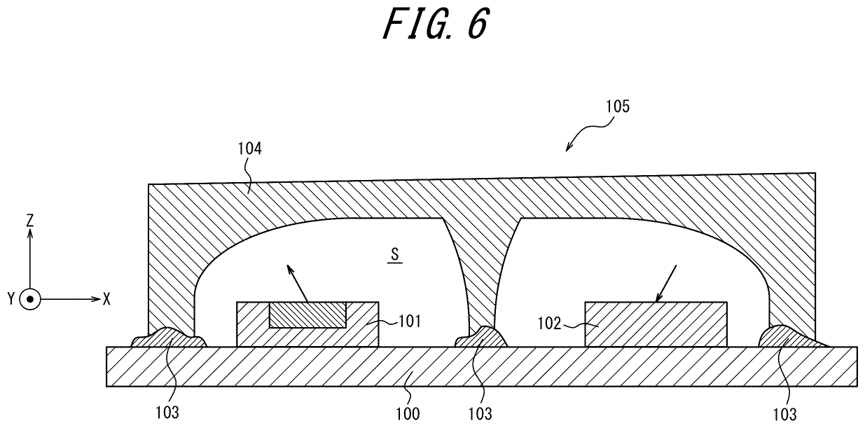

### DETAILED DESCRIPTION

The following provides a detailed description of an embodiment of the present disclosure with reference to the drawings. Note that elements of configuration that are the same are, as a general rule, allotted the same reference sign and are not repeatedly described. Ratios of the height and width of configurations are exaggerated in the drawings relative to their actual ratios in order to facilitate description.

Moreover, in order to facilitate description in the present specification, “up” refers to a light-guiding section side as illustrated in the drawings and “down” refers to a substrate side as illustrated in the drawings. However, “up” and “down” are merely set for convenience and should not be interpreted as limitations.

Furthermore, the phrase “roughly zero” as used in the present specification means a numerical range that is close to substantially zero and also encompasses a numerical range from slightly above zero to slightly below zero.

Also, the term “fix” as used in the present specification means to reduce the degree of freedom of movement in all of three orthogonal directions.

### Gas Detection Apparatus

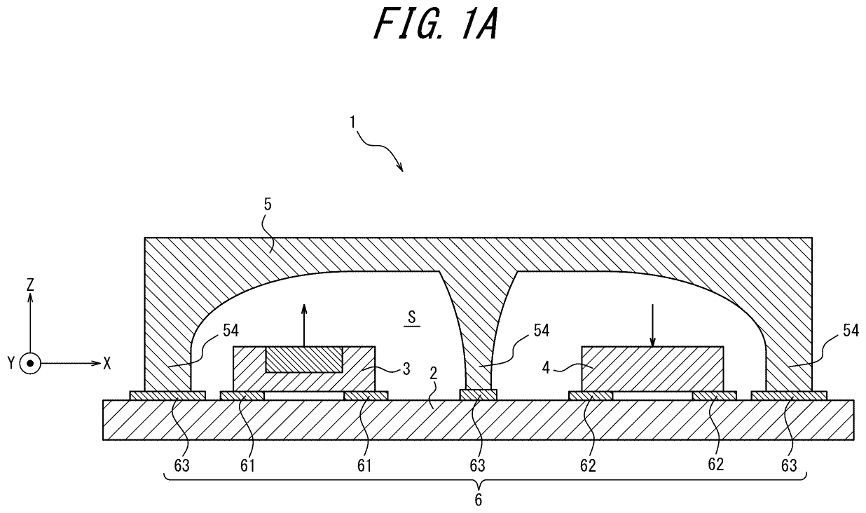

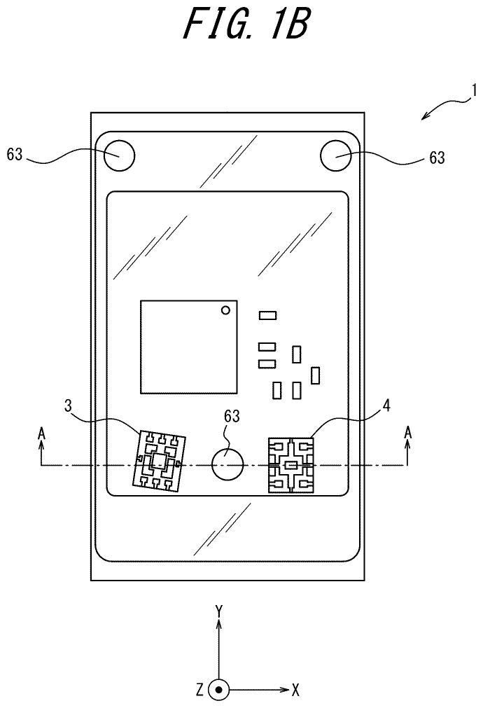

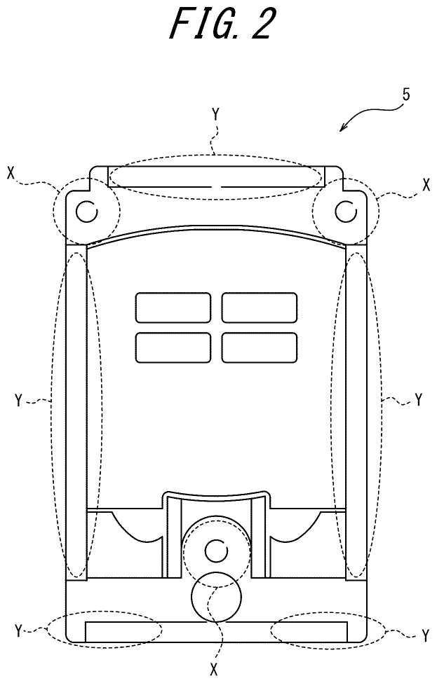

The following describes an example of configuration of a gas detection apparatus 1 according the present embodiment with reference to FIG. 1A, FIG. 1B, and FIG. 2.

FIG. 1A is a schematic cross-sectional view along a line A-A indicated in FIG. 1B that illustrates an example of configuration of the gas detection apparatus 1. In FIG. 1A and FIG. 1B, Cartesian coordinates are set such that an X direction and a Y direction are horizontal directions relative to a substrate 2 and a Z direction is a perpendicular direction relative to the substrate 2. The gas detection apparatus 1 is, for example, a small-sized apparatus having an X direction length of 10 mm to 25 mm, a Y direction length of 15 mm to 35 mm, and a Z direction length of 4 mm to 12 mm.

The gas detection apparatus 1 includes a substrate 2, a light-emitting section 3, a light-receiving section 4, a light-guiding section 5, and position reference sections 6. The position reference sections 6 include first position reference sections 61, second position reference sections 62, and third position reference sections 63 (position reference sections in contact with leg sections 54). The gas detection apparatus 1 is, for example, an NDIR (Non Dispersive InfraRed) apparatus that detects the concentration of a detection subject gas that has been introduced into the apparatus based on the amount of infrared absorption by the detection subject gas. The detection subject gas may be carbon dioxide, methane, water vapor, propane, formaldehyde, carbon monoxide, hydrogen sulfide, nitrogen monoxide, nitrous oxide, ammonia, sulfur dioxide, an alcohol (methanol, ethanol, etc.), a refrigerant gas (R32, R1234yf, etc.), MCH (methylcyclohexane), a mixed gas of any of these gases, or the like, for example.

The configuration of the gas detection apparatus in the present embodiment enables adoption for light-emitting/receiving apparatuses in applications other than gas detection. In other words, the present disclosure also encompasses disclosed matter derived by reinterpreting the “gas detection apparatus” described above as an “optical concentration measurement apparatus”, “optical physical quantity measurement apparatus”, “light-emitting/receiving apparatus”, “optical apparatus”, or the like. For example, it is possible to detect a state of a light path space (for example, the presence or concentration of a specific component in a fluid as one example other than a gas). For example, this can be adopted in a component detection apparatus, a component concentration measurement apparatus, or the like for a substance (for example, water or body fluid) that is present in a light path space between a light-emitting section and a light-receiving section. In a case in which the substance that is present in the light path space is blood, for example, the component detection apparatus or the component concentration measurement apparatus can be used for measuring the concentration of glucose in the blood, for example.

The component detection apparatus or the component concentration measurement apparatus can measure the glucose concentration among blood sugar by measuring absorption of light at a wavelength of 1 μm to 10 μm. In measurement of the glucose concentration among blood sugar, it is preferable to measure absorption of light at 1.6 μm, 2.0 μm to 2.3 μm, and 9.6 μm. Thus, it is possible to realize a non-invasive glucose concentration meter having a small size, high accuracy, and high reliability. By using such a glucose concentration meter, a diabetes patient can accurately check their blood sugar value by themself without damaging the skin as in an invasive method, for example. Higher accuracy administration of medication (for example, insulin) can also be realized based on the checked blood sugar value.

### Substrate

The substrate 2 has the light-emitting section 3, the light-receiving section 4, a control section, and so forth mounted on a main surface side thereof. In addition, the substrate 2 has the first position reference sections 61, the second position reference sections 62, and the third position reference sections 63 provided at the main surface side thereof. The light-emitting section 3 is provided at the first position reference sections 61. The light-receiving section 4 is provided at the second position reference sections 62. The light-guiding section 5 is provided at the third position reference sections 63. Note that the main surface is a surface where the light-guiding section 5 is provided among surfaces of the substrate 2 having a largest area.

The provision of the light-emitting section 3 at the first position reference sections 61 on the substrate 2 sets the position of the light-emitting section 3 in a perpendicular direction relative to the main surface of the substrate 2. The provision of the light-receiving section 4 at the second position reference sections 62 on the substrate 2 sets the position of the light-receiving section 4 in a perpendicular direction relative to the main surface of the substrate 2. The provision of the light-guiding section 5 at the third position reference sections 63 on the substrate 2 sets the position of the light-guiding section 5 in a perpendicular direction relative to the main surface of the substrate 2.

In other words, setting of the position of the light-emitting section 3, the position of the light-receiving section 4, and the position of the light-guiding section 5 in a perpendicular direction relative to the main surface of the substrate 2 also sets the position of the light-guiding section 5 relative to the light-emitting section 3 or the light-receiving section 4. This restricts variation (roughly tens of micrometers) of the relative distance between the light-guiding section 5 and the light-emitting section 3 or light-receiving section 4 and can thereby inhibit deterioration of optical properties of the gas detection apparatus 1.

The substrate 2 may be a printed board, a flexible printed board, a rigid flexible board, or a ceramic board, for example. The substrate 2 may include metal wiring, a base material, a resin, and so forth. The base material may be paper, glass cloth, polyimide film, PET film, ceramic, or the like, for example. The resin may be phenolic resin, epoxy resin, polyimide resin, bismaleimide triazine resin, fluororesin, polyphenylene oxide resin, or the like, for example.

### Light-Emitting Section

The light-emitting section 3, in response to driving current or driving voltage supplied from the control section, emits light of a wavelength band including a wavelength that is absorbed by the detection subject gas. For example, the light-emitting section 3 may emit light of a wavelength band from a wavelength of not less than 2.0 μm to a wavelength of not more than 12.0 μm. No specific limitations are placed on the configuration of the light-emitting section 3 so long as it emits light of a wavelength band including a wavelength that is absorbed by the detection subject gas. The light-emitting section 3 may further include an optical filter having a function of selectively transmitting light of part of the wavelength band.

The light-emitting section 3 may be an LED (Light Emitting Diode), a lamp, a laser (Light Amplification by Stimulated Emission of Radiation), an organic light-emitting section, a MEMS (Micro Electro Mechanical Systems) heater, a VCSEL (Vertical Cavity Surface Emitting Laser), a PCSEL (Photonic Crystal Surface Emitting Laser), or the like, for example. The light-emitting section 3 may include an auxiliary optical section having a light focusing function or a wavelength selection function. The auxiliary optical section may be a lens, a wavelength selective filter, a diffraction grating, or the like, for example.

The light-emitting section 3 is mounted on the substrate 2. The light-emitting section 3 is positioned at a first position by the first position reference sections 61 and is fixed on the substrate 2 via solder, for example. The solder is provided in regions where the light-emitting section 3 and the first position reference sections 61 are opposite each other and around those regions and is spread out at the surfaces of the first position reference sections 61. The light-emitting section 3 is electrically connected to electronic components via wiring including the first position reference sections 61. It should be noted that the solder is extremely thin and does not affect deviation of the position of the light-guiding section 5 relative to the light-emitting section 3.

The first position is an ideal position at which there is a good balance of light focusing efficiency and propagation efficiency of light propagated from the light-emitting section to the light-receiving section via the light-guiding section and is a position at which deviation relative to an ideal position of the light-guiding section 5 relative to the light-emitting section 3 in a perpendicular direction relative to the main surface of the substrate 2 is minimal (i.e., a position at which variation of the relative distance between the light-emitting section 3 and the light-guiding section 5 is roughly zero). As a result of the light-emitting section 3 being positioned at the first position by the first position reference sections 61, deterioration of optical properties (light propagation efficiency or light focusing efficiency) in the gas detection apparatus 1 can be inhibited, and deterioration of gas detection function can be prevented.

The relative distance between the light-emitting section 3 and the light-guiding section 5 is preferably roughly 1 to 20 times the width across corners of the light-emitting section 3, more preferably not more than 15 times the width across corners of the light-emitting section 3, and even more preferably not more than 10 times the width across corners of the light-emitting section 3. Specifically, the relative distance between the light-emitting section 3 and the light-guiding section 5 may be roughly 2 mm. Note that the relative distance between the light-emitting section 3 and the light-guiding section 5 referred to here may be the distance between a light emission center of the light-emitting section 3 and the center of an optical functional surface of the light-guiding section 5 that directly receives light radiating from the light-emitting section. For example, in a case in which the light-guiding section 5 includes a quadric surface mirror that collimates light radiating from the light-emitting section 3, the distance between the center of the quadric surface mirror and the light emission center of the light-emitting section 3 may be taken to be the relative distance between the light-emitting section 3 and the light-guiding section 5. The width across corners of the light-emitting section 3 is the width across corners of a region having a light emission function in the light-emitting section 3 (i.e., a light-emitting surface). For example, in a case in which the light-emitting section 3 is a resin-sealed LED, the width across corners of a light-radiating surface of the LED may be taken to be the width across corners of the light-emitting section 3. In this manner, it is possible to restrict variation of the relative distance between the light-emitting section 3 and the light-guiding section 5 and to maintain good optical properties of the gas detection apparatus 1 even upon reduction of size or height of the gas detection apparatus 1 as a result of the position of the light-emitting section 3 and the position of the light-guiding section 5 in a perpendicular direction relative to the substrate 2 being set.

The light-emitting section 3 is preferably a surface light source. The gas detection apparatus 1 can maintain good optical properties even when the light-emitting section 3 is a surface light source because variation of the relative distance between the light-emitting section 3 and the light-guiding section 5 is restricted. In contrast to a surface light source such as an LED or MEMS heater with which light is only radiated at a light-emitting surface side, a point light source such as a light bulb results in radiation of light at all solid angles. Therefore, adopting a surface light source as the light-emitting section 3 can cause efficient propagation of light from the light-emitting section to the light-receiving section and can suppress stray light, thereby enabling reduction of deterioration of gas detection function caused by stray light.

### Light-Receiving Section

The light-receiving section 4 has sensitivity in a wavelength band including a wavelength that is absorbed by the detection subject gas and receives light that has passed through the detection subject gas. For example, the light-receiving section 4 may receive light of a wavelength band from a wavelength of not less than 2.0 μm to a wavelength of not more than 12.0 μm. The light-receiving section 4 outputs a detection signal indicating the concentration of the detection subject gas to the control section in accordance with the amount of light that the light-receiving section 4 receives. The amount of light that the light-receiving section 4 receives decreases with increasing concentration of the detection subject gas and increases with decreasing concentration of the detection subject gas. The light-receiving section 4 may include an auxiliary optical section having a light focusing function or a wavelength selection function. The auxiliary optical section may be a lens, a wavelength selective filter, a diffraction grating, or the like, for example.

The light-receiving section 4 may be a photodiode, a phototransistor, a thermopile, a pyroelectric sensor, a bolometer, a photoacoustic detector, or the like, for example.

The light-receiving section 4 is mounted on the substrate 2. The light-receiving section 4 is positioned at a second position by the second position reference sections 62 and is fixed on the substrate 2 via solder, for example. The solder is provided in regions where the light-receiving section 4 and the second position reference sections 62 are opposite each other and around those regions and is spread out at the surfaces of the second position reference sections 62. The light-receiving section 4 is electrically connected to electronic components via wiring including the second position reference sections 62. It should be noted that the solder is extremely thin and does not affect deviation of the position of the light-guiding section 5 relative to the light-receiving section 4.

The second position is an ideal position at which there is a good balance of light focusing efficiency and propagation efficiency of light propagated from the light-emitting section to the light-receiving section via the light-guiding section and is a position at which deviation relative to an ideal position of the light-guiding section 5 relative to the light-receiving section 4 in a perpendicular direction relative to the main surface of the substrate 2 is minimal (i.e., a position at which variation of the relative distance between the light-receiving section 4 and the light-guiding section 5 is roughly zero). As a result of the light-receiving section 4 being positioned at the second position by the second position reference sections 62, deterioration of optical properties in the gas detection apparatus 1 can be inhibited, and deterioration of gas detection function can be prevented.

The relative distance between the light-receiving section 4 and the light-guiding section 5 is preferably roughly 1 to 20 times the width across corners of the light-receiving section 4, and more preferably not more than 15 times the width across corners of the light-receiving section 4. Specifically, the relative distance between the light-receiving section 4 and the light-guiding section 5 may be roughly 2 mm. The relative distance between the light-receiving section 4 and the light-guiding section 5 referred to here may be the distance between a light reception center of the light-receiving section 4 and the center of an optical functional surface of the light-guiding section 5 that directly propagates light to the light-receiving section 4. For example, in a case in which the light-guiding section 5 includes a quadric surface mirror that focuses light toward the light-receiving section 4, the distance between the center of the quadric surface mirror and the light reception center of the light-receiving section 4 may be taken to be the relative distance between the light-receiving section 4 and the light-guiding section 5. The width across corners of the light-receiving section 4 may be the width across corners of a region having a light reception function in the light-receiving section 4 (i.e., a light-receiving surface). For example, in a case in which the light-receiving section 4 is a resin-sealed photodiode, the width across corners of a light-receiving surface of the photodiode may be taken to be the width across corners of the light-receiving section 4. In this manner, it is possible to restrict variation of the relative distance between the light-receiving section 4 and the light-guiding section 5 and to maintain good optical properties of the gas detection apparatus 1 even upon reduction of size or height of the gas detection apparatus 1 as a result of the position of the light-receiving section 4 and the position of the light-guiding section 5 in a perpendicular direction relative to the main surface of the substrate 2 being set.

In a case in which the light-guiding section 5 is an imaging optical system, the area of the light-receiving surface of the light-receiving section 4 is preferably not smaller than the size of an image that is formed on the light-receiving surface of the light-receiving section 4 by the light-guiding section 5. Specifically, the area of the light-receiving surface of the light-receiving section 4 is preferably not less than 1.5 times, and more preferably not less than 2 times the area of the image. This keeps the image within the light-receiving surface and means that the amount of light that is propagated from the light-emitting section 3 to the light-receiving section 4 does not change even in a situation in which the light-guiding section 5 deforms due to environmental change of temperature, humidity, etc. or degradation over time and in which there is a slight change of the position at which the image is formed on the light-receiving surface of the light-receiving section 4. Consequently, deterioration of gas detection performance of the gas detection apparatus 1 can be reduced. The image referred to here may be an area having an illuminance of 10% or more relative to peak illuminance in the light-receiving surface. On the other hand, in a situation in which the area of the light-receiving surface is excessively large relative to the area of the image, this reduces the average illuminance of light received by the light-receiving section 4 and reduces a detection signal that is output by the light-receiving section 4. Therefore, the area of the light-receiving surface of the light-receiving section 4 is preferably not more than 16 times the area of the image.

### Light-Guiding Section

The light-guiding section 5 guides light that is emitted by the light-emitting section 3 to the light-receiving section 4 through single or multiple reflection in a detection space S. The light-guiding section 5 optically connects the light-emitting section 3 and the light-receiving section 4. The light-guiding section 5 may, for example, be an imaging optical system in which a plurality of quadric surface mirrors are combined.

The light-guiding section 5 is positioned at a third position by the third position reference sections 63 and is mounted on the substrate 2 through fitting or the like, for example.

The third position is an ideal position at which there is a good balance of light focusing efficiency and propagation efficiency of light propagated from the light-emitting section to the light-receiving section via the light-guiding section and is a position at which deviation relative to an ideal position of the light-guiding section 5 relative to the light-emitting section 3 or the light-receiving section 4 in a perpendicular direction relative to the main surface of the substrate 2 is minimal (i.e., a position at which variation of the relative distance between the light-guiding section 5 and the light-emitting section 3 or light-receiving section 4 is roughly zero). As a result of the light-guiding section 5 being positioned at the third position by the third position reference sections 63, deterioration of optical properties in the gas detection apparatus 1 can be inhibited, and deterioration of gas detection function can be prevented.

The light-guiding section 5 includes a resin housing, a reflective section, and so forth. The material of the resin housing may be LCP (liquid-crystal polymer), PP (polypropylene), PEEK (polyether ether ketone), PA (polyamide), PPE (polyphenylene ether), PC (polycarbonate), PPS (polyphenylene sulfide), PMMA (polymethyl methacrylate resin), a rigid resin in which two or more of these resins are mixed, or the like, for example. The material of the reflective section may be metal, glass, ceramic, stainless steel, or the like, for example. From a viewpoint of improving detection sensitivity, the reflective section is preferably formed of a material having a small light absorption coefficient and high reflectance. Examples of such materials include aluminum, gold, and silver-containing alloys, dielectrics, and laminates thereof. Moreover, the reflective section may be formed of gold or an alloy layer containing gold from a viewpoint of reliability and change over time. Furthermore, the light-guiding section 5 may contain beads, a filler, or the like in any of these materials.

The light-guiding section 5 preferably has a dielectric laminate film formed at the surface of a metal layer at its inner surface. This makes it possible to increase the reflectance. Moreover, the light-guiding section 5 is preferably subjected to vapor deposition, sputtering, or plating on the resin housing at its inner surface. This can improve productivity of the gas detection apparatus 1 and also enables weight reduction. Furthermore, since the difference between thermal expansion coefficients of the substrate 2 and the light-guiding section 5 can be narrowed, thermal deformation of the gas detection apparatus 1 can be inhibited, and variation of detection sensitivity can be restricted.

No specific limitations are placed on the production process of the light-guiding section 5, and the light-guiding section 5 may be shaped by machining, pressing, or the like, for example. Moreover, the light-guiding section 5 may be shaped by injection molding in consideration of productivity, etc. In a case in which the light-guiding section 5 includes a plurality of reflective sections, the plurality of reflective sections may be shaped as a single body. By shaping the reflective sections as a single body, it is possible to simplify an assembly step and increase productivity. Moreover, by shaping the light-guiding section 5 as a single body, it is possible to inhibit deterioration of optical performance due to error arising in assembly. Furthermore, in a case in which the light-guiding section 5 is composed of a plurality of members, joint sections that join these members may cause deviation of position due to degradation over time or environmental change (temperature change or humidity change) and bring about deterioration of optical performance. Therefore, by shaping the light-guiding section 5 as a single body, it is possible to inhibit deterioration caused by joint sections such as described above and to increase reliability of the gas detection apparatus 1.

The light-guiding section 5 may include various optical elements such as an ellipsoidal mirror, a flat mirror, a concave mirror, a convex mirror, a lens, and a diffraction grating.

The light-guiding section 5 may further include a gas port, a dust filter, and so forth. The gas port introduces the detection subject gas into the detection space S or withdraws the detection subject gas from the detection space S. Although the gas port is preferably provided in an upper part of the light-guiding section 5, the gas port may be provided in a side part of the light-guiding section 5. Providing the gas port in an upper part of the light-guiding section 5 makes it easy to attach the dust filter to the gas port and also simplifies the production process of the light-guiding section 5. The dust filter is attached to the gas port and prevents infiltration of dust, dirt, and so forth into the detection space S. The dust filter may be a non-woven fabric or a PTFE film, for example.

As illustrated in FIG. 2, the light-guiding section 5 is fixed on the substrate 2 by a fixing section in regions Y. The fixing section may be an adhesive, for example. The adhesive preferably has a thickness of not less than 50 μm and not more than 1 mm. In a case in which the substrate 2 is a printed board and in which the light-guiding section 5 is fixed on the substrate 2 by an adhesive, regions on the substrate 2 where the adhesive is applied preferably have a prepreg exposed thereat, and regions on the light-guiding section 5 where the adhesive is applied are preferably subjected to surface roughening or embossing. Since a prepreg results in a higher adhesion strength with an adhesive than a copper pattern or a solder resist and since an anchoring effect readily arises as a result of surface roughening or embossing, it is possible to more robustly fix the light-guiding section 5 and the substrate 2. Alternatively, the light-guiding section 5 may be fixed on the substrate 2 in the regions Y through crimping, fitting, pins, screws, claws, grommets, welding, or the like. Leg sections 54 of the light-guiding section 5 are in contact with the third position reference sections 63 that are provided on the substrate 2 in regions X.

Robustness of the gas detection apparatus 1 is increased as a result of the light-guiding section 5 being fixed on the substrate 2 by the fixing section in the regions Y. In addition, fixing of the light-guiding section 5 on the substrate 2 by the fixing section in the regions Y means that it is not necessary to provide an adhesive in the regions X to fix the light-guiding section 5 and the substrate 2 as is conventionally the case. Consequently, deviation relative to the ideal position of the light-guiding section 5 that is caused by variation of thickness of the adhesive can be restricted. Moreover, as a result of the position of the light-guiding section 5 in a perpendicular direction relative to the substrate 2 being set by the light-guiding section 5 including leg sections 54 and these leg sections 54 being in contact with the third position reference sections 63 of the substrate 2, and as a result of the light-guiding section 5 being fixed on the substrate 2 by the fixing section in the regions Y, it is possible to restrict deviation of the position of the light-guiding section 5 relative to the light-emitting section 3 or the light-receiving section 4 caused by variation in production while also fixing the light-guiding section 5 at a desired position on the substrate 2. In other words, as a result of the fixing section that fixes the light-guiding section 5 to the substrate 2 and the third position reference sections 63 and the leg sections 54 that set the position of the light-guiding section 5 in a perpendicular direction relative to the substrate 2 being separated as independent structures, it is possible to relieve deviation of the position of the light-guiding section 5 that arises in a case in which an adhesive is responsible for both fixing the light-guiding section 5 to the substrate 2 and positioning the light-guiding section 5 in a perpendicular direction relative to the substrate 2.

A plurality of leg sections 54 are included. In a case in which the contact area with the substrate 2 per one leg section 54 is sufficiently smaller than the area of the main surface of the substrate 2 and in which the contact area can be relatively regarded as a point, the number of leg sections 54 may be three or more in order to define a plane, with the preferred number of leg sections 54 being three. A sufficiently small area referred to here may mean that the contact area with the substrate 2 per one leg section 54 is not more than 1/10 of the area of the main surface of the substrate 2. Moreover, when the contact area with the substrate 2 per one leg section 54 is too small, it is not possible to achieve sufficient mechanical strength. Therefore, the contact area with the substrate 2 per one leg section 54 may be not less than 1/1500 of the area of the main surface of the substrate 2, and the contact area with the substrate 2 per one leg section 54 may be 0.2 mm² or more. Furthermore, in a case in which the maximum length of a contact surface of at least one of the leg sections 54 with the substrate 2 is not small relative to the maximum length of the main surface of the substrate 2, the contact surface of that leg section 54 with the substrate 2 can be relatively regarded as a line segment, and thus the number of leg sections 54 may be two or more since a plane is defined so long as there are at least two leg sections 54. The maximum length referred to here may be the maximum length joining any two points within the surface, and the phrase “not small” may mean that the maximum length of a contact surface of at least one of the leg sections 54 with the substrate 2 is not less than 1/10 relative to the maximum length of the main surface of the substrate 2. The upper limit for the maximum length of a contact surface of one of the leg sections 54 with the substrate 2 is 90% of the maximum length of the main surface of the substrate 2.

In a case in which an adhesive is adopted as the fixing section, an appropriate gap that takes into account the thickness of the adhesive may be provided between the light-guiding section 5 and the substrate 2 where the adhesive is applied. Specifically, a Z direction dimension of the light-guiding section 5 in the regions Y may be reduced by an amount corresponding to the thickness of the adhesive. As a consequence, the light-guiding section 5 is only directly in contact with the substrate in the regions X where it is opposite the third position reference sections 63, and a suitable adhesive thickness can be ensured, thereby enabling accurate setting of the Z direction positions of the light-guiding section 5 and the substrate 2 while also enabling robust fixing of the light-guiding section 5 and the substrate 2.

Note that even when an adhesive is adopted as the fixing section, deviation of the position of the light-guiding section 5 relative to the light-emitting section 3 or the light-receiving section 4 is restricted because the light-emitting section 3 is positioned at the first position by the first position reference sections 61, the light-receiving section 4 is positioned at the second position by the second position reference sections 62, the light-guiding section 5 is positioned at the third position by the third position reference sections 63, and at least the position of the light-emitting section 3, the position of the light-receiving section 4, and the position of the light-guiding section 5 in a perpendicular direction relative to the main surface of the substrate 2 are set relative to the substrate 2.

### Position Reference Sections

The position reference sections 6 include first position reference sections 61, second position reference sections 62, and third position reference sections 63. The first position reference sections 61, the second position reference sections 62, and the third position reference sections 63 are each provided on the substrate 2. The first position reference sections 61 set the position of the light-emitting section 3 in a perpendicular direction relative to the main surface of the substrate 2. The second position reference sections 62 set the position of the light-receiving section 4 in a perpendicular direction relative to the main surface of the substrate 2. The third position reference sections 63 set the position of the light-guiding section 5 in a perpendicular direction relative to the main surface of the substrate 2.

The first position reference sections 61 may, for example, be lands (surface pads) on the substrate 2. The first position reference sections 61 are formed of an electrically conductive material such as copper. The first position reference sections 61 position the light-emitting section 3 at the first position and are electrically connected to the light-emitting section 3 via solder, for example. The shape of the first position reference sections 61 is not specifically limited and may be a rectangular shape, for example. In a case in which the light-emitting section 3 has a plurality of electrical terminals, a plurality of the first position reference sections 61 may be present. In a case in which the first position reference sections 61 are lands, the surfaces of the lands may be subjected to gold plating to prevent degradation due to oxidation or corrosion. Moreover, in a case in which the first position reference sections 61 are lands, it is preferable that a resist is not present on the whole land surface because the position of the light-emitting section 3 is not precisely set when a resist is present at the surface. Furthermore, in a case in which the first position reference sections 61 are lands, a through hole or a non-through hole may be present in the surface.

The second position reference sections 62 may, for example, be lands (surface pads) on the substrate 2. The second position reference sections 62 are formed of an electrically conductive material such as copper. The second position reference sections 62 position the light-receiving section 4 at the second position and are electrically connected to the light-receiving section 4 via solder, for example. The shape of the second position reference sections 62 is not specifically limited and may be a rectangular shape, for example. In a case in which the light-receiving section 4 has a plurality of electrical terminals, a plurality of the second position reference sections 62 may be present. In a case in which the second position reference sections 62 are lands, the surfaces of the lands may be subjected to gold plating to prevent degradation due to oxidation or corrosion. Moreover, in a case in which the second position reference sections 62 are lands, it is preferable that a resist is not present on the whole land surface because the position of the light-receiving section 4 is not precisely set when a resist is present at the surface. Furthermore, in a case in which the second position reference sections 62 are lands, a through hole or a non-through hole may be present in the surface.

The third position reference sections 63 may, for example, be lands (surface pads) on the substrate 2. The third position reference sections 63 are formed of an electrically conductive material such as copper. The third position reference sections 63 position the light-guiding section 5 at the third position and are joined to the light-guiding section 5 through fitting, for example. In a case in which the third position reference sections 63 are lands, the surfaces of the lands may be subjected to gold plating to prevent degradation due to oxidation or corrosion. Moreover, in a case in which the third position reference sections 63 are lands, it is preferable that a resist is not present on the whole land surface because the position of the light-guiding section 5 is not precisely set when a resist is present at the surface. Furthermore, in a case in which the third position reference sections 63 are lands, a through hole or a non-through hole may be present in the surface. The shape of the third position reference sections 63 is not specifically limited and may be a circular shape, for example. The area of the third position reference sections 63 in plan view of the main surface of the substrate is preferably larger than the area of a contact section of the light-guiding section that is in contact with the third position reference sections 63 in order that the light-guiding section 5 is precisely positioned in a perpendicular direction relative to the substrate main surface even when there is slight displacement of the light-guiding section 5 relative to the substrate 2 in a parallel direction to the substrate main surface. In a case in which a plurality of the third position reference sections 63 are present and in which the area per one third position reference section 63 is sufficiently smaller than the area of the main surface of the substrate 2 and can be relatively regarded as a point, the number of third position reference sections 63 may be three or more in order to define a plane, with the preferred number of third position reference sections 63 being three. A sufficiently small area referred to here may mean that the area per one third position reference section 63 is not more than 1/10 of the area of the main surface of the substrate 2. Moreover, when the area of the third position reference sections 63 is too small, it is not possible to achieve sufficient mechanical strength. Therefore, the area per one third position reference section 63 may be not less than 1/1500 of the area of the main surface of the substrate 2, and the area per one third position reference section 63 may be 0.2 mm² or more. Furthermore, in a case in which the maximum length of at least one third position reference section 63 is not small relative to the maximum length of the main surface of the substrate 2, that third position reference section 63 can be relatively regarded as a line segment, and thus the number of third position reference sections 63 may be two or more since a plane is defined so long as there are at least two third position reference sections 63. The maximum length referred to here may be the maximum length joining any two points within the surface, and the phrase “not small” may mean that the maximum length of at least one third position reference section 63 is not less than 1/10 relative to the maximum length of the main surface of the substrate 2. The upper limit for the maximum length of the third position reference sections 63 is 90% of the maximum length of the main surface of the substrate 2. In a case in which a plurality of third position reference sections 63 are present, it is preferable that at least two of the third position reference sections 63 are in proximity to edges of the substrate in plan view of the substrate main surface in order to stabilize joining of the substrate 2 and the light-guiding section 5. For example, “in proximity to edges of the substrate” may mean a distance that is not more than ⅓ of a longitudinal distance of the substrate main surface. “In proximity to edges of the substrate” preferably means a distance that is not more than ¼ of the longitudinal distance of the substrate main surface. Moreover, since processing accuracy of the third position reference sections 63 is poor when the third position reference sections 63 are too close to edges of the substrate, the third position reference sections 63 are preferably separated by not less than 0.2 mm from the edges of the substrate in plan view of the substrate main surface. Furthermore, in a case in which a plurality of third position reference sections 63 are present, it is preferable that any two of the third position reference sections 63 are separated by not less than ½ of the longitudinal distance of the substrate main surface in plan view of the substrate main surface in order to stabilize joining of the substrate 2 and the light-guiding section 5. Also, the maximum distance between any two of the third position reference sections 63 is 90% of the maximum length of the main surface of the substrate 2.

The first position reference sections 61, the second position reference sections 62, and the third position reference sections 63 are formed by a similar step and may, for example, be formed by a commonly known printed board production step. The first position reference sections 61, the second position reference sections 62, and the third position reference sections 63 each have a thickness of approximately 10 μm to approximately 80 μm that is extremely thin compared to the thickness of the gas detection apparatus 1 (approximately 5 mm). By forming the first position reference sections 61, the second position reference sections 62, and the third position reference sections 63 by a similar step, it is possible to ensure uniform thickness thereof. Moreover, by forming the first position reference sections 61, the second position reference sections 62, and the third position reference sections 63 from the same material, it is possible to increase positioning accuracy and consequently realize a gas detection apparatus 1 with which good optical properties are obtained. Furthermore, by arranging the first position reference sections 61, the second position reference sections 62, and the third position reference sections 63 in proximity, it is possible to reduce the effect of thickness non-uniformity of lands arising in a production step and to more precisely ensure uniform thickness of these position reference sections. For example, by arranging at least one third position reference section 63 on a perpendicular bisector of a line segment joining any of the first position reference sections 61 and the second position reference sections 62 in plan view of the substrate main surface, it is possible to more precisely ensure uniform thickness of these position reference sections. Any line joining the light-emitting section 3 and the light-receiving section 4 in plan view of the substrate main surface may be taken to be the line segment joining any of the first position reference sections 61 and the second position reference sections 62 referred to here.

The third position reference sections 63 may be provided in a region Rt such as can be seen with reference to FIG. 22 of JP 2021-144027 A, for example. In this case, the first position reference sections 61, the second position reference sections 62, and the third position reference sections 63 are arranged in a region comparatively close together on the substrate 2, which can reduce the effect of thickness non-uniformity of lands arising in a production step and more precisely ensure uniform thickness of these position reference sections. Note that in FIG. 22 of JP 2021-144027 A, a straight line Lp is a perpendicular bisector of a line segment joining a center of a light-emitting section 3 and a center of a light-receiving section 4. A straight line Le is a straight line passing through the light-emitting section 3 in parallel to the straight line Lp. A straight line Ld is a straight line passing through the light-receiving section 4 in parallel to the straight line Lp. The region Rt is a largest region in a main surface of a substrate that is sandwiched between the straight line Le and the straight line Ld.

As set forth above, the gas detection apparatus 1 includes position reference sections 6 on the substrate 2 that set at least a position of the light-emitting section 3, a position of the light-receiving section 4, and a position of the light-guiding section 5 in a perpendicular direction relative to the substrate 2. This makes it possible to solve the problem in the conventional art that variation in production due to differing adhesive thickness or the like causes deviation of the position of a light-guiding section 5 relative to a light-emitting section 3 or a light-receiving section 4. Consequently, variation of the relative distance between the light-guiding section 5 and the light-emitting section 3 or light-receiving section 4 is restricted, which enables prevention of deterioration of optical properties in the gas detection apparatus 1, such as image blurring and reduction of the amount of light that is propagated to the light-receiving section 4. Moreover, a gas detection apparatus 1 with which good optical properties are obtained can be realized even upon reduction of the size or height of the gas detection apparatus 1 (for example, even when the relative distance between the light-guiding section 5 and the light-emitting section 3 or light-receiving section 4 is shortened from approximately 10 mm to approximately 5 mm).

### Control Section

The control section may include at least one of a general-purpose processor that executes functions according to a program that is read and a dedicated processor specialized for particular processing. The general-purpose processor may be a micro controller unit (MCU), for example. The dedicated processor may be an application specific integrated circuit (ASIC), for example. The control section may include an AFE (Analog Front End), an ADS (Analog to Digital Converter), or non-volatile/volatile memory.

The control section controls the light-emitting section 3 and the light-receiving section 4. For example, the control section may compute the concentration of the detection subject gas based on a detection signal that has been output from the light-receiving section 4. The control section can individually control just the light-emitting section 3 in a situation in which the light-receiving section 4 is not used in the gas detection apparatus 1 and can individually control just the light-receiving section 4 in a situation in which the light-emitting section 3 is not used in the gas detection apparatus 1. The control section may be provided inside of the gas detection apparatus 1 or may be provided outside of the gas detection apparatus 1.

In the gas detection apparatus 1 according to the present embodiment, the position reference sections 6 that set at least the position of the light-emitting section 3, the position of the light-receiving section 4, and the position of the light-guiding section 5 in a perpendicular direction relative to the main surface of the substrate 2 are provided on the main surface of the substrate 2. This makes it possible to realize a gas detection apparatus 1 with which good optical properties are obtained even upon reduction of the size or height of the gas detection apparatus 1.

### Modified Example

Next, an example of configuration of a gas detection apparatus 1A according to a modified example is described.

The gas detection apparatus 1A according to the modified example differs from the gas detection apparatus 1 according to the present embodiment in terms that the gas detection apparatus 1A according to the modified example further includes a fourth position reference section in addition to first position reference sections 61, second position reference sections 62, and third position reference sections 63 and in terms that a light-guiding section 5A further includes a second fixing section in a region opposite the fourth position reference section. Since other configurations are the same as in the gas detection apparatus 1 according to the present embodiment, repeated description thereof is omitted.

The fourth position reference section is provided on the substrate 2. The fourth position reference section sets a position of the light-guiding section 5A in a horizontal direction relative to the main surface of the substrate 2. The direction in which the position is set may just be a single direction, and there may be a degree of freedom of the position in a certain direction. A plurality of fourth position reference sections may be present.

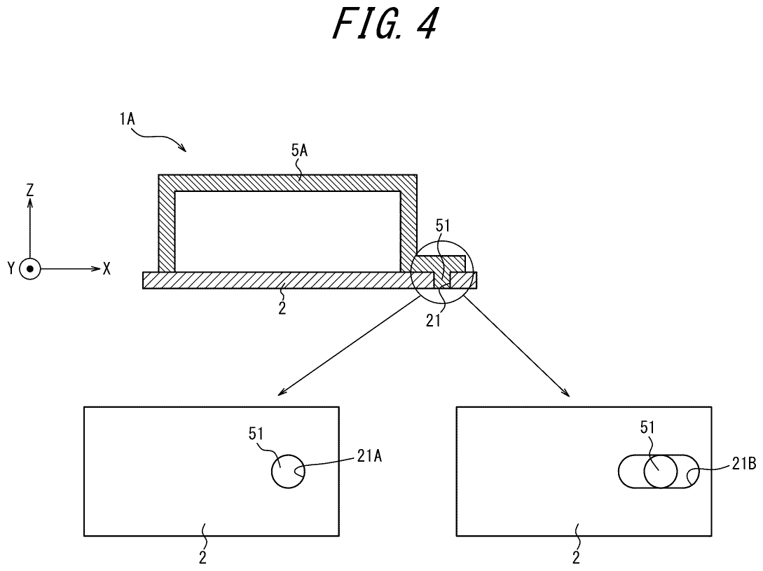

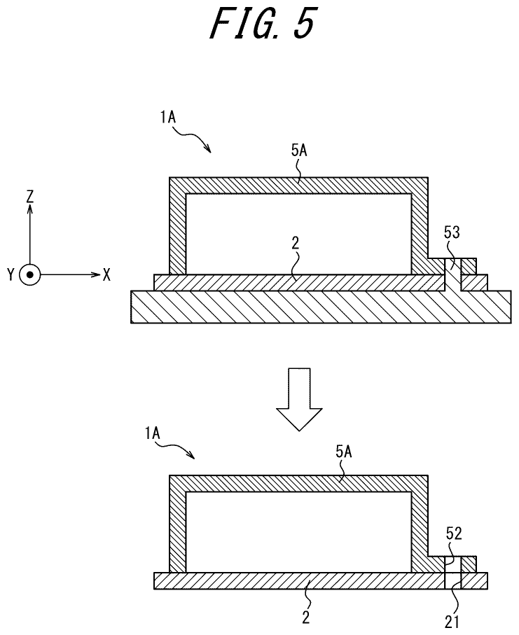

The fourth position reference section may, for example, be a through hole 21 on the substrate 2 as illustrated in FIG. 4. The position of the light-guiding section 5A in a horizontal direction can be set through a pin 51 that has been formed on the light-guiding section 5A being inserted into the through hole 21 of the substrate 2. The through hole 21 may be a circular hole 21A or may be an elongated hole 21B where a circle is stretched in one direction. For example, in a case in which the pin 51 is cylindrical, the position of the light-guiding section 5A in a horizontal direction can be completely set when the through hole 21 is the circular hole 21A and can be set in just one direction when the through hole 21 is the elongated hole 21B. Moreover, it is also possible to set the position of the light-guiding section 5A in a horizontal direction by providing a through hole 52 in the light-guiding section 5A that has approximately the same outer shape as the through hole 21 on the substrate 2 and by inserting a pin 53 through the two through holes 21 and 52 as illustrated in FIG. 5. After the position of the light-guiding section 5A in a horizontal direction has been set by the above-described pin 53 and the light-guiding section 5A and the substrate 2 have been fixed by the fixing section, the pin 53 may be withdrawn from the two through holes 21 and 52.

The fourth position is an ideal position at which there is a good balance of light focusing efficiency and propagation efficiency of light propagated from the light-emitting section to the light-receiving section via the light-guiding section and is a position at which deviation relative to an ideal position of the light-guiding section 5A relative to the light-emitting section 3 or light-receiving section 4 in a horizontal direction relative to the substrate 2 is minimal (i.e., a position at which variation of the relative distance between the light-guiding section 5A and the light-emitting section 3 or light-receiving section 4 is roughly zero). As a result of the light-guiding section 5A being positioned at the fourth position by the fourth position reference section, deterioration of optical properties in the gas detection apparatus 1A can be inhibited, and deterioration of gas detection function can be prevented.

The fourth position reference section is preferably provided in proximity to the light-emitting section 3 and the light-receiving section 4 on the substrate 2. For example, the fourth position reference section may be provided on a perpendicular bisector of a line segment joining the light-emitting section 3 and the light-receiving section 4. Through this configuration, it is possible to further reduce deviation of the horizontal direction position of the light-guiding section 5A with the light-emitting section 3 and the light-receiving section 4 on the substrate 2 even in a situation in which the light-guiding section 5A has rotated with the fourth position reference section as a center of rotation.

The light-guiding section 5A further includes a second fixing section in a region opposite the fourth position reference section. The light-guiding section 5A is fixed on the substrate 2 by the second fixing section. The second fixing section may, for example, be a pin having a fitting function. For example, the light-guiding section 5A may be fixed on the substrate 2 and the position thereof in a horizontal direction relative to the substrate 2 may be set through insertion of the pin into the fourth position reference section.

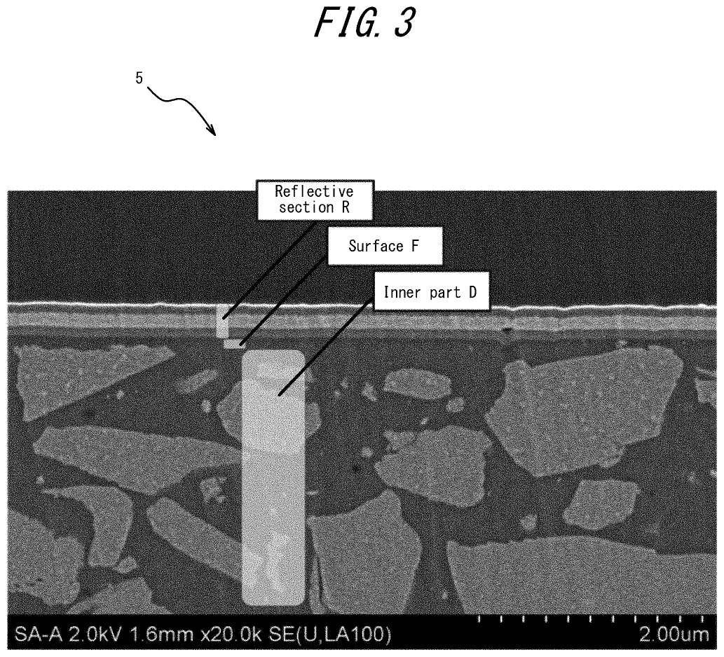

The surface of the light-guiding section 5A has preferably been subjected to particular surface processing treatment such as primer treatment, coating treatment, or plating treatment, for example. The light-guiding section 5A preferably has a high filler content ratio in an inner part D relative to a surface F as illustrated in FIG. 3. This can increase smoothness of a reflective section R that is in contact with the surface F. Moreover, when the pin is inserted into the fourth position reference section, for example, it is possible to restrict looseness of the light-guiding section 5A relative to the substrate 2 and to stably position the light-guiding section 5A on the substrate 2. Furthermore, in a case in which the pin is in contact with a third position reference section 63, it is possible to restrict looseness of the light-guiding section 5A relative to the substrate 2 and to stably position the light-guiding section 5A on the substrate 2. Consequently, the position of the light-guiding section 5A can be precisely set, and optical properties of the gas detection apparatus 1 can be further improved.

The second fixing section is preferably formed of a thermosetting material. The second fixing section may, for example, be formed of a thermosetting resin such as an epoxy resin, a resin having a ceramic material added to a thermosetting resin, a metal paste, or the like.

In the gas detection apparatus 1A according to the modified example, the first position reference sections 61, the second position reference sections 62, and the third position reference sections 63 that set the position of the light-emitting section 3, the position of the light-receiving section 4, and the position of the light-guiding section 5A in a perpendicular direction relative to the substrate 2 are provided on the substrate 2, and the fourth position reference section that sets the position of the light-guiding section 5A in a horizontal direction relative to the substrate 2 is also provided on the substrate 2. This makes it possible to realize a gas detection apparatus 1A with which good optical properties are obtained even upon reduction of the size or height of the gas detection apparatus 1A.

Although the embodiment set forth above has been described as a representative example, it would be obvious to a person of ordinary skill in the art that numerous changes and substitutions can be made within the essence and the scope of the present disclosure. Accordingly, the present disclosure should not be construed as being limited by the embodiment set forth above, and various modifications and changes are possible without deviating from the scope of the claims.

1. A gas detection apparatus comprising:
a substrate;
a light-emitting section that is provided on the substrate;
a light-receiving section that is provided on the substrate;
a light-guiding section that is provided on the substrate and that guides light that has been emitted from the light-emitting section to the light-receiving section; and
a fixing section that fixes the light-guiding section and the substrate, wherein
the light-guiding section includes at least two leg sections,
the substrate includes at least two position reference sections that are in contact with the leg sections,
a position of the light-guiding section in a perpendicular direction relative to the substrate is set by the position reference sections, and
the fixing section is a structure that is independent of the position reference sections and the leg sections.

2. A gas detection apparatus comprising:
a substrate;
a light-emitting section that is provided on the substrate;
a light-receiving section that is provided on the substrate;
a light-guiding section that is provided on the substrate and that guides light that has been emitted from the light-emitting section to the light-receiving section; and
a fixing section that fixes the light-guiding section and the substrate, wherein
the light-guiding section includes at least three leg sections,
the substrate includes at least three position reference sections that are in contact with the leg sections,
a position of the light-guiding section in a perpendicular direction relative to the substrate is set by the position reference sections, and
the fixing section is a structure that is independent of the position reference sections and the leg sections.

3. The gas detection apparatus according to claim 1, wherein
the light-guiding section includes three of the leg sections, and
the substrate includes three of the position reference sections.

4. The gas detection apparatus according to claim 1, wherein
the substrate further includes a first position reference section and a second position reference section,
the light-emitting section is provided on the first position reference section,
the light-receiving section is provided on the second position reference section,
the first position reference section sets a position of the light-emitting section in a perpendicular direction relative to the substrate,
the second position reference section sets a position of the light-receiving section in a perpendicular direction relative to the substrate, and
the first position reference section, the second position reference section, and the position reference sections that are in contact with the leg sections are formed of the same material.

5. The gas detection apparatus according to claim 1, wherein
the light-emitting section is fixed on the substrate via solder, and
the light-receiving section is fixed on the substrate via solder.

6. The gas detection apparatus according to claim 4, wherein the first position reference section, the second position reference section, and the position reference sections that are in contact with the leg sections are lands on the substrate.

7. The gas detection apparatus according to claim 1, wherein the fixing section is an adhesive.

8. The gas detection apparatus according to claim 1, wherein the substrate further includes a horizontal direction position reference section that sets a position of the light-guiding section in a horizontal direction relative to the substrate.

9. The gas detection apparatus according to claim 1, wherein a relative distance between the light-guiding section and the light-emitting section or the light-receiving section is not more than 10 times a width across corners of the light-receiving section.

10. The gas detection apparatus according to claim 1, wherein the light-guiding section has a large filler content ratio in an inner part relative to a surface.

11. The gas detection apparatus according to claim 1, wherein the light-receiving section has a light-receiving area that is not smaller than a size of an image.

12. The gas detection apparatus according to claim 1, wherein the light-emitting section is a surface light source.

13. The gas detection apparatus according to claim 1, wherein at least one location of the position reference sections is provided on a perpendicular bisector of a line segment joining the light-emitting section and the light-receiving section.

14. The gas detection apparatus according to claim 1, wherein at least two locations of the position reference sections are provided in proximity to edges of the substrate.

15. The gas detection apparatus according to claim 1, wherein any two locations of the position reference sections are separated by not less than ½ of a longitudinal distance at a main surface of the substrate.

16. The gas detection apparatus according to claim 1, wherein at least one of the position reference sections is provided in a largest region in a main surface of the substrate that is sandwiched between a straight line passing through the light-emitting section in parallel to a perpendicular bisector of a line segment joining a center of the light-emitting section and a center of the light-receiving section and a straight line passing through the light-receiving section in parallel to the perpendicular bisector.
